(19) United States
(12) Patent Application Publication
(10) Pub. No.: US 2007/0202338 A1
(43) Pub. Date: Aug. 30, 2007

(54) METHOD FOR HARDENING AT A SURFACE A COMPONENT, DEVICES HAVING ONE OR MORE HARDENED SURFACES AND DEVICES FOR RETAINING AND REPRESENTING FOR USE A PLURALITY OF COMPONENTS

(76) Inventor: Michael Hennessy Sullivan, Droitwich (GB)

Correspondence Address: HOFFMAN WARNICK & D'ALESSANDRO, LLC, 75 STATE STREET, 14TH FLOOR, ALBANY, NY, 12207, US

(21) Appl. No.: 11/565,277

(22) Filed: Nov. 30, 2006

Related U.S. Application Data
(63) Continuation of application No. PCT/GB05/02155, filed on May 31, 2005.

(30) Foreign Application Priority Data
Jun. 1, 2004 (GB) 0412183.6

(51) Int. Cl. B32B 9/04

(52) U.S. Cl. 428/411.1

(57) ABSTRACT

A method for hardening at a surface a component, the component being formed of a plastics material, comprises softening the component at a surface using supercritical carbon dioxide and incorporating into the component at the surface a material to harden the surface. There is also disclosed a device having one or more surfaces hardened according to the aforementioned method and a device for retaining and presenting for use one or more components which comprises a plurality of components arranged in a disc portion and means for moving one or more of the components from a rest position to an in use position.

The present invention relates to a method for hardening at a surface a component formed of a plastics material and devices having one or more hardened surfaces. In particular, the component is preferably formed of a plastics material such as a polymer. In a further embodiment, the present invention relates to devices for retaining and presenting for use a plurality of components, such as lancets.

Medical devices such as lancets, scalpels and surgical scissors, all of which have a sharpened edge, are conventionally formed of metal, such as stainless steel. This causes the devices to be expensive and therefore the devices may not generally be disposed of after each use but reused after sterilisation. If the devices are not sterilised. effectively between uses, contamination could occur with serious consequences There is therefore a need to provide a device which is economical to produce, which may be disposable after a single use and which is formed by a process which is not likely to leave toxic residue in or on the device.

Plastics materials such as polymers are not generally used in these situations because the inherent mechanical properties of the components require a hardness not normally present in plastics materials, particularly where a sharp edge is required. Considerable problems are known to exist in the manufacture from polymers of sharp components and components which require hardwearing qualities.

One or more embodiments of the present invention seek to address these problems by enabling an improvement in the manufacturing, durability and disposability of components all or part of which are formed of a plastics material.

A further embodiment of the invention seeks to address problems in conventional devices, such as blood sugar level monitoring devices or other devices in which a new component such as a lancet must be inserted for each use which is not only time consuming but means that, after each use, the used component with the exposed tip must be disposed of carefully.

According to a first aspect of the present invention there is provided a method for hardening at a surface a component, the component being formed of a plastics material, the method comprising the steps of:
softening the component at a surface using supercritical carbon dioxide, and
incorporating into the component at the surface a material to harden the surface.

Preferably, the step of incorporating into the component a material comprises incorporating a ceramic material.

The step of softening the component using supercritical carbon dioxide preferably comprises:
placing the component in a pressure vessel;
introducing into the pressure vessel an amount of carbon dioxide; and
increasing the pressure and temperature in the pressure vessel such that the carbon dioxide becomes supercritical to soften the component at a surface.

In a preferred embodiment, the step of introducing into the pressure vessel an amount of carbon dioxide comprises introducing into the pressure vessel a mixture of carbon dioxide and a substance for enabling a miscible blend of substances to be created. In a preferred embodiment, the substance is preferably an alcohol such as methanol, or ethanol.

Preferably, the step of incorporating into the softened component a material comprises applying to the softened component a metal alkoxide reagent to incorporate a ceramic into the softened component, such as tetraethoxysilane (TEOS) and/or titanium isoproxide (TiOP). The supercritical carbon dioxide may be used as a carrier for the metal alkoxide reagent.

In a further preferred embodiment, the method further comprises the steps of:
introducing water into the pressure vessel after the step of incorporating into the softened component a material; and
increasing the pressure and the temperature in the pressure vessel after the step of introducing the water to induce hydrolysis and condensation reactions in the metal alkoxide reagent incorporated into the softened component for producing one or more substantially continuous ceramic domains in the surface.

Preferably, the pressure is increased up to around 150 bar (15 MPa) after introducing the water and the temperature is increased up to around 120 C.

In a further preferred embodiment, the pressure in the pressure vessel is reduced after the step of increasing the pressure and the temperature in the pressure vessel following the introduction of the water.

The temperature of the pressure vessel may then be adjusted the temperature to allow annealing and/or post curing techniques to be applied to the hardened surface of the component in the pressure vessel.

The depth to which the material, such as a ceramic material, is incorporated into the plastics material may be dependent on the plastics material from which the component is formed, the time for which the plastics material is exposed to the metal alkoxide reagent and/or the pressure applied to the softened component. In a preferred embodiment, the material is incorporated into the component to a depth of up to around 50 microns, or preferably up to around 20 microns.

The plastics material may preferably comprise a polymer material According to a second aspect of the present invention there is provided a device having one or more surfaces hardened according to the above-defined method.

Preferably the device comprises one or more lancets having a tip portion having a surface hardened according to the above-defined method.

The method according to one or more preferred embodiments of the present invention is particularly advantageous in that it enables the hardening of one or more surfaces of devices to be achieved at an economical cost.

Furthermore, components or parts of components hardened using the above defined process in accordance with a preferred embodiment of the invention may be made safe for disposal if, for example, they include a hardened sharp edge, by touching the sharp edge to a hot plate for a period of time, such as less than, for example, 1 second, to melt the material forming the sharpened edge thereby rounding the edge to inhibit puncturing. The temperature of such a hot plate should be sufficient to melt the basic polymer material from which the component is made. This may be particularly useful in situations where disposal of sharp medical components may be dangerous, particularly if contaminated, and it is therefore desirable to be provide a means for safe disposal.

The method for hardening the surface layer(s) of a plastics component described above is particularly advantageous in the hardening of plastics components for use, for example, as products having a sharp blade such as medical devices including lancets and scissors, lawnmower blades, razor blades, and food processors, as well as plastics products in which a hardened surface is advantageous, for example, windows, optical screens, watch face covers, mobile telephone display faces, lenses for spectacles, hub caps, wheel trims, headlight lenses, gear box components, valve components and other wear resistant components. Embodiments of the present invention enable a very hard surface to be created on a plastics material which may also improve resistance to scratching in these products.

In some applications, it may be desirable to harden the entire plastics component or only a part of the surface, depending on the brittleness of the plastics structure being hardened. If the core of the plastics material remains untreated, the core material will provide its own strength within the component. The depth to which the hardening material penetrates the plastics material is controllable by varying the pressure to which the component being hardened is subjected in the pressure vessel and the time for which it is subjected to a particular pressure.

Also, devices embodying the present invention may be particularly useful in the medical field where it would be desirable to have components which are of a low cost and could therefore be disposed of after a single use to minimise the risk of contamination.

According to a third aspect of the present invention there is provided a device comprising a plurality of components, one or more of the components having one or more surfaces hardened according to the method defined above, the plurality of components being arranged in a disc portion, the device further comprising means for moving one or more of the components from a rest position to an in use position.

Preferably, the plurality of components comprises a plurality of lancets each having a tip portion, the tip portion having one or more of the one or more hardened surfaces.

According to a fourth aspect of the present invention there is provided a device for retaining and presenting for use one or more components, the device comprising a plurality of components, arranged in a disc portion, the device further comprising means for moving one or more of the components from a rest position to an in use position.

Such an embodiment is particularly advantageous as it is convenient to use as several components may be pre-installed in the device ready for use. Also, in a preferred embodiment, each component may preferably be retained in the device after use and a new component presented for use as desired until all components have been used.

Preferably, the plurality of components comprises a plurality of lancets, each component having a tip portion, the tip portion having one or more of the one or more hardened surfaces.

Preferably the tip portion of each component extends in a plane substantially parallel to the plane of the disc portion or in a plane substantially perpendicular to the plane of the disc portion.

In a preferred embodiment, the tip portion of each component extends from a free end portion of the component, each component having a fixed end attached to a central disc portion, the components extending radially from the central disc portion, and the free end of each component being spaced from the free end of the adjacent component to permit independent movement of the tip portion of each component between the rest position and the in use position.

Preferably, the means for moving the components comprises a spring mechanism, the spring mechanism having a resiliently biased portion and a contact portion, wherein the resiliently biased portion is arranged such that when it is biased against its natural bias the resiliently biased portion urges the contact portion into contact with one of the plurality of components to move the component to the in use position.

In a preferred embodiment, the resiliently biased portion is arranged such that on return to its naturally biased state the resiliently biased portion allows the component to move from the in use position to the rest position.

Preferably, the means for moving the components further comprises means for rotating the disc portion.

In an alternative preferred embodiment, the means for moving the components comprises a first section and a second section, the first and second sections being joined by a hinge, the tip portion of the components being attachable to one or other of the first and second portions, the first and second sections being arranged such that in use pressure applied to the hinge of any one of the plurality of components causes movement of that component to the in use position and/or the rest position.

Preferably, the first and second sections are integrally formed, and the tip portion may be joined to one or other of the first portion or the second portion by a hinge.

In a further preferred embodiment, the disc portion comprises:
a cover portion;
a base portion;
an annular body portion extending between the base portion and the cover portion;
a recess bounded by the annular body portion; and
a plurality of compartments within the annular body portion, each compartment being associated with a corresponding component from the plurality of components, the compartments being arranged to contain a fluid substance;
wherein each component is spaced from any one or more of the other components and is arranged in use to extend through the compartment associated with the component and into the recess; and
wherein the means for moving each component is locatable in the recess, the means for moving being arranged such that actuation of the means for moving causes a component to move from the rest position to the in use position in which the tip of the component pierces the cover portion and extends therethrough to permit egress of fluid from the associated compartment.

Preferably, the body portion is a frustro-conically shaped annular portion tapering from the base portion to the cover portion.

According to a fifth aspect of the present invention there is provided a blood sugar level monitor comprising the device defined above.

Embodiments of the present invention will now be described by way of example with reference to the accompanying drawings in which:

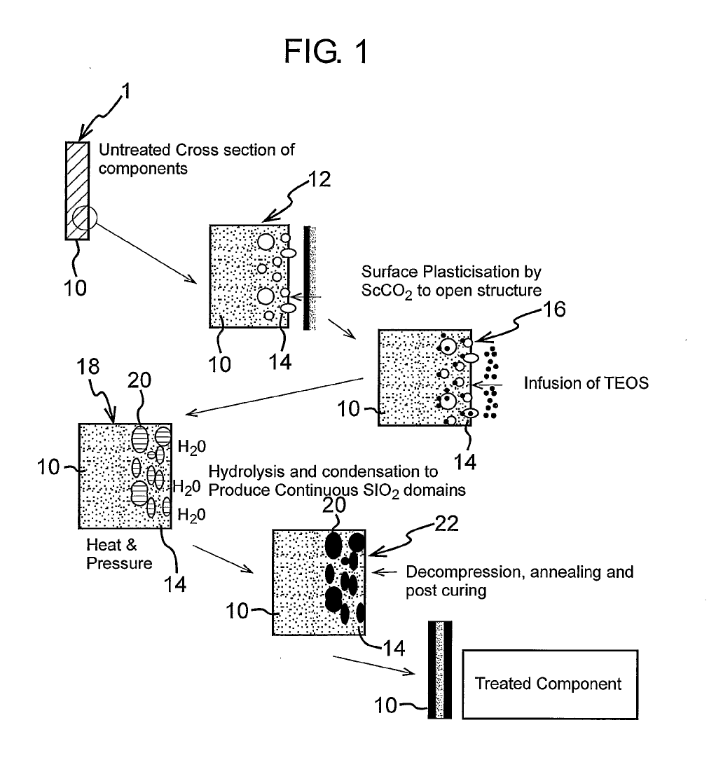

FIG. 1 is a schematic diagram showing the steps in a process according to an embodiment of the present invention;

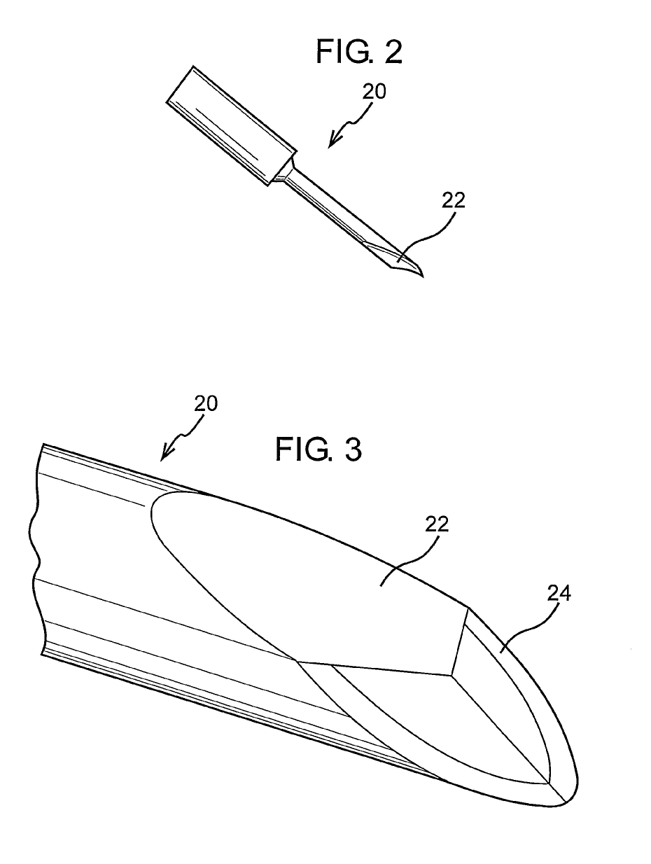

FIG. 2 is a perspective view of a lancet according to an embodiment of the present invention;

FIG. 3 is a perspective view of the tip of the lancet of FIG. 2;

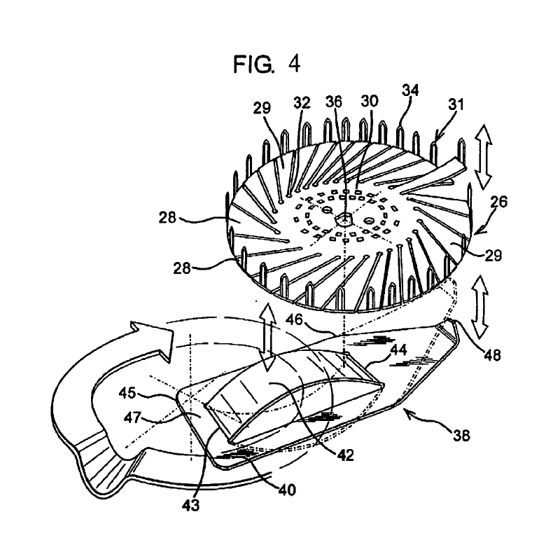

FIG. 4 is a exploded parts perspective view of a magazine comprising a plurality of lancets according to an embodiment of the present invention;

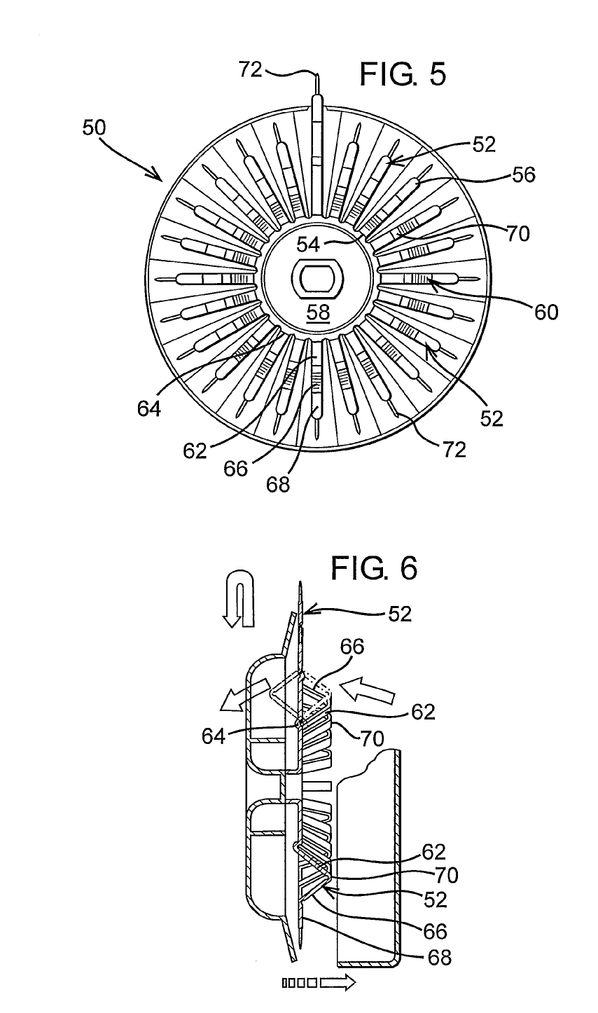

FIG. 5 is a plan view of an alternative magazine comprising a plurality of lancets according to an alternative embodiment of the present invention;

FIG. 6 is a cross-sectional view of the magazine of FIG. 5 showing its operation;

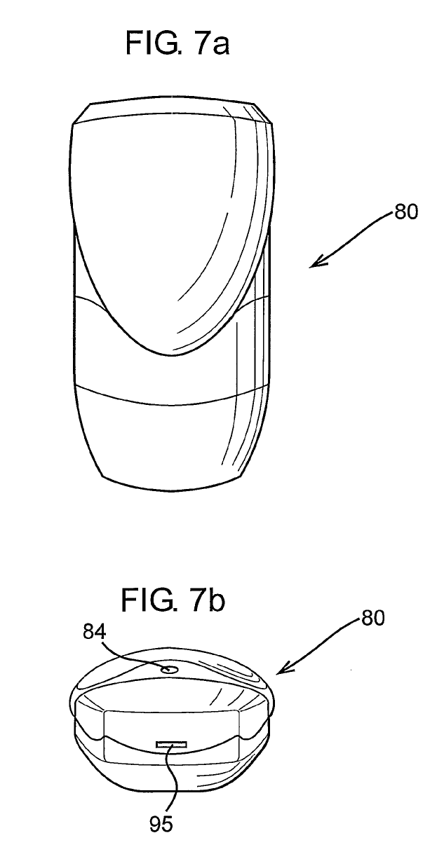

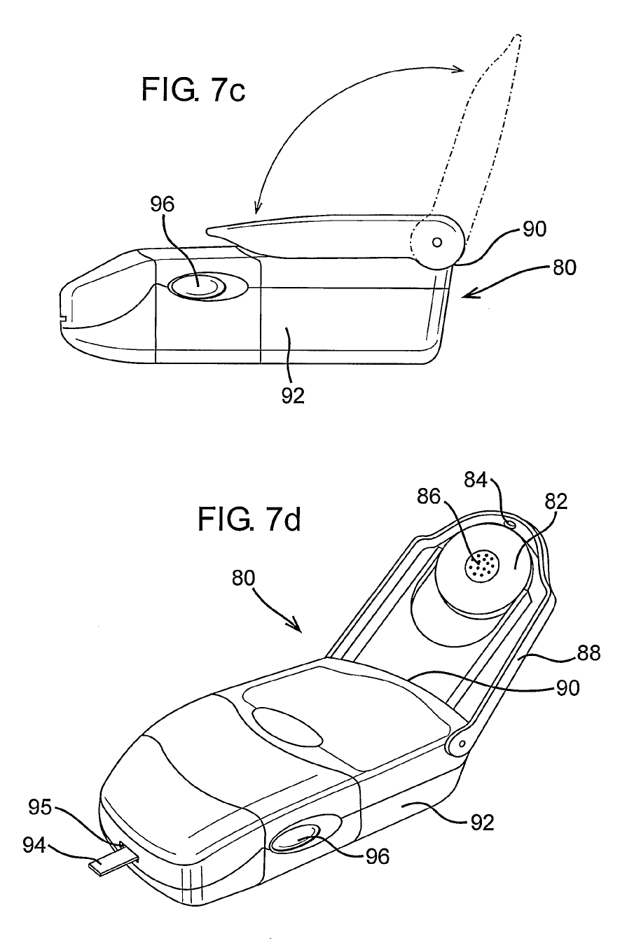

FIGS. 7a to d show plan, end, side and perspective views respectively of a housing for the lancet magazines of FIGS. 4 or 5;

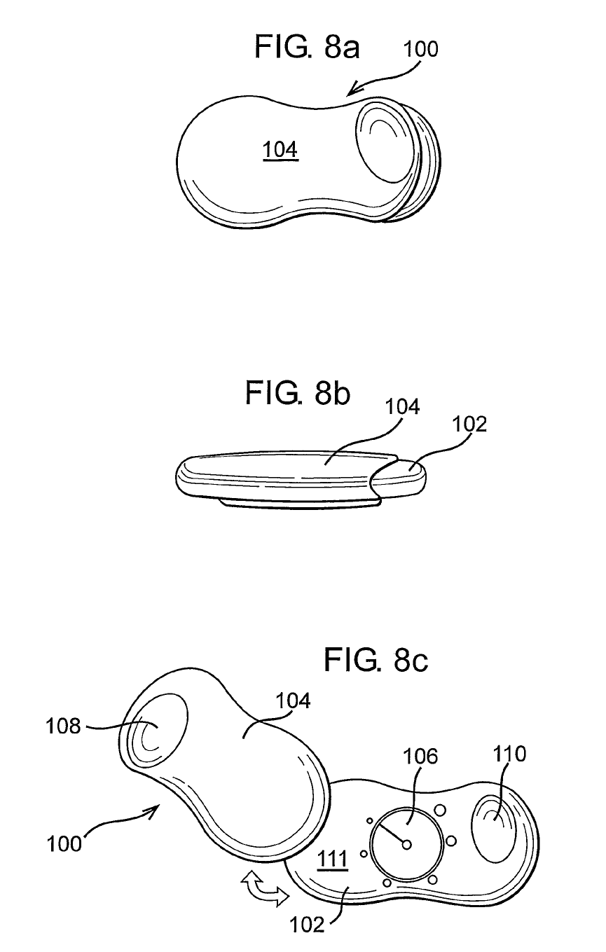

FIGS. 8a to c show a plan view in the closed position, a side view and a plan view in the open position of a further alternative housing for the lancet magazines of FIGS. 4 or 5; and

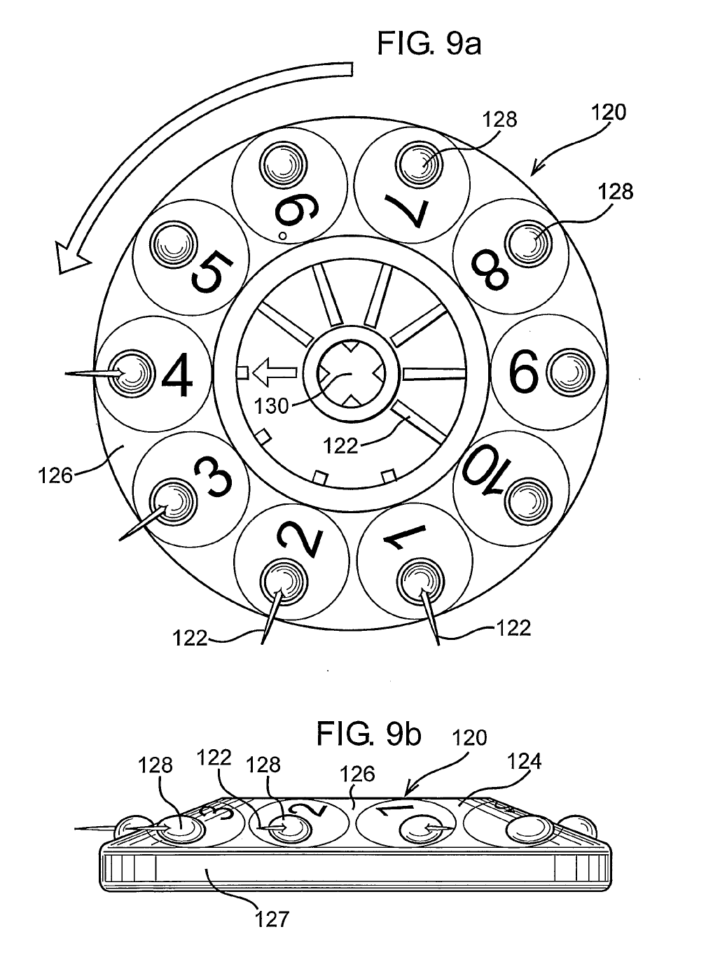

FIGS. 9a and 9b are a plan view and a side view respectively of a still further alternative housing for a lancet magazines according to a preferred embodiment of the invention.

FIG. 1 illustrates the steps in a process according to a preferred embodiment of the invention for hardening at a surface a component farmed of a plastics material, such as a polymer. In a first stage 1, the component 10 to be hardened is placed in a pressure vessel (not shown). The pressure vessel is then filled with a mixture of, for example, carbon dioxide and methanol (or, in an alternative preferred embodiment functional equivalents to one or other of these substances) and the pressure and temperature in the pressure vessel are raised so that the carbon dioxide becomes supercritical.

Under these conditions, the supercritical carbon dioxide or the supercritical carbon dioxide and methanol mixture softens or plasticizes, in a second stage 12, all or part of a surface layer 14 of the plastics component 10 down to a certain depth. A metal alkoxide reagent, such as tetraethoxysilane (TEOS) and/or titanium isoproxide (TiOP) is introduced into the pressure vessel in a third stage 16, using the supercritical carbon dioxide as a carrier. The TEOS and/or TiOP are incorporated into the surface layer(s) 14 of the plastics component causing a ceramic to be formed. The depth to which the TEOS and/or TiOP penetrate the component will depend on the pressure in the pressure vessel and/or the time for which the component is exposed to the supercritical carbon dioxide carrying the TEOS and/or TiOP.

Water is then introduced into the pressure vessel in a fourth stage 18 and the pressure in the pressure vessel is increased to, for example, around 150 bar (15 MPa). The pressure vessel is also heated in this fourth stage 18 to a temperature of, for example, around 120 C. The water, together with the supercritical carbon dioxide, induces hydrolysis and condensation reactions in the alkoxide incorporated into the surface layer(s) 14 of the plastics component 10 to produce one or more continuous silicon dioxide domains 20 in the surface layer(s) 14 down to a certain depth of, for example, up to 20 or 50 microns.

The pressure in the pressure vessel is then reduced in a fifth stage 22 and the temperature of the pressure vessel is adjusted to allow annealing and post curing techniques to be applied to the hardened plastics component 10 in the pressure vessel.

The hardened component is then removed from the pressure vessel.

The amounts and types of chemicals used will vary according to the plastics material (for example the type of polymer) being hardened and this is dependent on each product application. Possible types of plastics materials which could be used include, for example, Liquid Crystal Polymer (LCP), nylon, Polycarbonate (PC) and PolyEtherEtherKetone (PEEK), amongst others. Preferably the plastics material is a material having a porous gel structure when softened.

Using the above-described process according to an embodiment of the present invention, it is possible to obtain a surface hardness in the outer surface layer(s) 14 of the plastics component of at least 7 Mohs, which is approximately the hardness of quartz. Also, it is possible to grind, polish and/or sharpen the hardened components treated using the above-described process according to an embodiment of the present invention and scratch-resistant surfaces may be provided which are suitable for use in devices such as medical devices, optical screens, and wear-resistant components.

Components or parts of components hardened using the above-described process according to an embodiment of the present invention may have a sharp edge which may be produced cost-effectively, to an edge radius of less than approximately 150 nm which is comparable to existing stainless steel blades and in accordance with British Standard BS 2982:1992. The sharpened edges of components or parts of components hardened using the above process may be capable of retaining their sharpness for at least as long as their stainless steel counterparts.

Components or parts of components hardened using the above process in accordance with a preferred embodiment of the invention may be made safe for disposal if, for example, they include a hardened sharp edge, by touching the sharp edge to a hot plate for a period of time, such as for less than 1 second, to increase the blade edge radius to more than 0.5 mm, for example, thereby rounding the edge to inhibit puncturing. The temperature of such a hot plate should be sufficient to melt the basic plastics material from which the component is made.

As mentioned above, the method for hardening the surface layer(s) of a plastics component described above with reference to FIG. 1 is particularly advantageous in the hardening of plastics components for use, for example, as products having a sharp blade such as medical devices including lancets and scissors, lawnmower blades, razor blades, and food processors, as well as plastics products in which a hardened surface is advantageous, for example, windows, optical screens, watch face covers, lenses for spectacles, mobile telephone display faces, hub caps, wheel trims, headlight lenses and other wear resistant components. One or more embodiments of the present invention enable a very hard surface to be created in a plastics material which may improve resistance to scratching in these products.

In some applications, it may be desirable to harden the entire plastics component or only a part of the surface, depending on the brittleness of the plastics structure being treated. If the core of the plastics material remains untreated, the core material will provide its own strength within the component. As mentioned above, the depth to which the ceramic penetrates the plastics material is controllable by varying the pressure to which the component being hardened is subjected in the pressure vessel and the time for which it is subjected to the supercritical carbon dioxide carrying the alkoxide reagent at a particular pressure.

The amounts and types of chemicals used will vary according to the plastics material (for example the type of polymer) being hardened and this is dependent on each product application. Possible types of plastics materials which could be used include, for example, Liquid Crystal Polymer (LCP), nylon, Polycarbonate (PC) and PolyEtherEtherKetone (PEEK), amongst others. Preferably the plastics material is a material having a porous gel structure when softened.

Sharp edges on components, such as lancets 20, of the type shown in FIGS. 2 and 3, may be preserved by forming the lancet 20 out of a plastics material and hardening all or just the tip 22 of the lancet 20 using the method according to a preferred embodiment of the present invention described above with reference to FIG. 1.

As shown in FIG. 3, the tip 22 of the lancet 20 may have a hardened surface layer 24 which has a graded structure richer in silica in the outermost layer and fading to pure plastics material (for example a polymer) at a depth of, preferably around 20 microns from the outer surface layer. Other depths may be desired, for example up to 50 microns, depending on the intended use of the lancet or component.

In a further preferred embodiment, as shown in FIG. 4, a disc (or magazine) 26 may be formed comprising a number of components, such as lancets 28 all or part of which may be made of a plastics material, such as a polymer, hardened according to the method described above with reference to FIG. 1. Alternatively, the components to be retained in the disc and then dispensed may be formed of some other material(s) such as metal.

In FIG. 4, the body portions 29 of the lancets 28 extend radially outwardly from a central disc portion 30 and in a plane substantially parallel to that of the central disc portion 30.

Each lancet 28 has a free end 31 and a fixed end 32, the fixed end 32 of each lancet 28 being attached to the central disc portion 30. The free end 31 of each lancet 28 comprises the tip 34 of the lancet 28 which extends in a plane substantially perpendicular to the plane of the body portion 29.

The central disc portion 30, the body portions 29 of the lancets 28 and the tips 34 of the lancets 28 may be formed of a plastics material such as a polymer, Alternatively, the central disc portion 30 and/or the body portions 29 of the lancets 28 may be formed of another material such as metal, with just the tip 34 of the lancet being formed of a plastics material hardened according to the method described above in connection with FIG. 1, in which case the tips 34 of the lancets may be hardened prior to construction of the magazine 26. Alternatively, all or part of the components such as the lancets 28 could be formed of some other material, such as a metal.

The disc (magazine) 26 may be mounted through its centrally extending bore 36 on a spindle (not shown) and arranged to be rotated in a stepped manner using a mechanism (not shown).

A spring mechanism 38 for exposing the lancets 28 in use may be formed from sheet material and may comprise a substantially planar rectangular portion 40 from which a bowed strip 42 fixed at both ends 43, 44 extends between the ends 45, 46 of the rectangular portion 40. The bowed strip 42 extends from a substantially planar surface 47 of the rectangular portion 40. The rectangular portion 40 tapers at one end 46 beyond one fixed end 44 of the bowed strip 42 and terminates in a pointed end 48 which is bent at substantially right angles to the plane of the rectangular portion 40.

Application of pressure to the bowed strip 42 in the direction towards the plane of the rectangular portion 40 will cause the bowed strip 42 to buckle suddenly, thereby forcing the pointed end 48 of the rectangular portion 40 to move sharply in a plane perpendicular to the plane of the rectangular portion 40. Releasing the pressure on the bowed strip 42 allows the strip to return to its natural rest position.

The spring mechanism 38 may be mounted below the magazine 26 carrying the lancets 28 such that the pointed end 48 is positioned adjacent the lancet 28 to be used in any current application. Depressing the bowed strip 42 of the spring mechanism 38 in the manner described above causes the pointed end 48 to strike the body portion 29 of the lancet to be used thereby forcing the lancet tip 34 into the in use position. In use, releasing the pressure applied to the bowed strip 42 through, for example, an actuation button on a device in which the magazine 26 and spring mechanism 38 are mounted, enables the bowed strip 42 to return to its natural rest position thereby enabling the lancet 28 being used to return to its rest position.

After use, the magazine (disc) 26 may be rotated to bring the next lancet into position ready for use.

In a further preferred embodiment, as shown in FIGS. 5 and 6, an alternative form of disc (or magazine) 50 may comprise a number of components such as lancets 52 all or part of which may be made of a plastics material, such as a polymer, hardened according to the method described above with reference to FIG. 1. Alternatively, all or part of the components could be formed of another type of material, such as metal. In this preferred embodiment, an array of lancets each having a fixed end 54 and a free end 56 are mounted circumferentially about a central disc portion 58. The body portions 60 of the lancets 52 extend radially from the central disc portion 58 substantially in the same plane as the central disc portion.

As shown in FIGS. 5 and 6, each lancet 52 is comprised of three preferably integrally formed sections, the first being an inner section 62, one end 64 of which is attached to the central disc portion 58. The second section is a centre section 66 and the third section is an outer section 68. The centre section 66 is hingedly joined to the outer and inner sections 62, 68 and the inner section 62 is hingedly joined to the central disc portion 58. The hinges joining the sections may be formed by substantially reducing the thickness of the material at this point to permit movement of one section relative to the other.

In the rest position, the inner section 62 and the centre section 66 are angled such that they form a point or apex 70 at their hinge which extends away from the plane of the central disc portion 68. In this rest position, the outer section 68 extends in a plane substantially parallel to that of the central disc portion 58.

The tip 72 of each of the lancets 52 extends outwardly from the free end 74 of the outer section 68 and in a plane substantially parallel to the plane of the central disc portion 58.

To operate the device of FIGS. 5 and 6, pressure is applied to the apex 70 of the triangle formed by the inner and centre sections 62, 66 forcing the apex 70 to move so that all three sections 62, 66 and 68 lie in the same plane. This forces the outer section 68 to move radially outwards exposing the tip 72 of the lancet 52 extending therefrom. If further pressure is applied, the inner and centre sections 62, 66 are forced through the plane of the central disc portion 58 thereby drawing the outer section 68 radially inwards and retracting the tip 72 of the lancet being used. The magazine 50 may then be rotated to bring the next lancet on the magazine into position ready for use.

FIGS. 7a to d show a housing 80 for use with the lancet magazines 26, 50 of FIGS. 4 or 5, and most preferably for use with the magazine 50 shown in FIG. 5 in which the tips 72 of the lancets 52 extend radially outwards. The housing 80 may form a portable handheld device suitable, for example, for use by diabetics who are required to test their blood sugar levels regularly by pricking a finger to draw blood which may then be tested.

The lancet magazine 50 of FIG. 5 may be encased in a casing 82 having an aperture 84 in its peripheral outer edge through which the tip 72 of the lancet being used may extend in use.

An actuating button 86 is located in the casing 82 at a position adjacent the apex 70 formed by the inner and centre sections 62, 66 such that depression of the actuation button 86 causes the apex 70 to move in the manner described above in connection with the operation of the device shown in FIGS. 5 and 6.

The casing 82 in which the magazine 50 is removably housed, is insertable into a receiving portion 88 of a device which may incorporate a blood sugar level monitor. The receiving portion 88 is hingedly attached along one edge 90 thereof to a body portion 92 incorporating the blood sugar level monitor. The testing strip 94 for the blood sample may be inserted into the body portion 92 through an aperture 95 therein.

In the closed position, the receiving portion 88 may be positioned such that it abuts a face of the body portion 92 so that the actuating button 86 is concealed and cannot be operated accidentally. An on-off switch 96 for the device may be located on the body portion 92.

The device 80 shown in FIGS. 7a to 7d may be used as follows. The receiving portion 88 may rotated about its hinge to expose the actuating button 86 on the casing of the magazine 50. The users finger may then be placed over the aperture 84 in the casing and the actuation button 86 depressed to force a lancet 52 of the magazine through the aperture 84 and into the users finger to draw blood.

A drop of blood from the users finger may then be placed on a measuring strip 94 which may be inserted through the aperture 95 in the body portion 92 of the device to enable the blood sugar level of the user to be determined by the device.

After all of the lancets in the magazine 50 have been used, the magazine may easily be replaced with a new magazine.

FIGS. 8a to c show an alternative housing 100 for the lancet magazines of FIGS. 4 or 5, and most preferably for use with the magazine 50 shown in FIG. 5 in which the tips 72 of the lancets 52 extend radially outwards. The housing 100 may form a portable handheld device suitable, for example, for use by diabetics to prick a finger to draw blood which may then be tested to determine the blood sugar level of the user.

The lancet magazine 50 may be placed into a cavity (not shown) in the housing 100 and a cover (also not shown) may be used to retain the magazine 50 in the cavity. The housing 100 comprises a body portion 102 and a pivotally attached housing cover portion 104. An actuation button 106 is located in the body portion 102 at a position adjacent the apex 70 formed by the inner and centre sections 62, 66 of the magazine 50 such that depression of the actuation button 106 causes the apex 70 to move in the manner described above in connection with the operation of the device shown in FIGS. 5 and 6. In use, once actuated by depression of the actuation button 106, the tip 72 of the lancet to be used from the magazine 50 may extend through an aperture (not shown) in the body portion 102.

The body portion 102 of the device shown in FIGS. 8a-8c may be ergonomically shaped so that when the device is gripped by a user, the users finger to be pricked comfortably rests along the side of the body portion 102 at a position through which the tip 72 of the lancet is to extend on depression of the actuation button 106.

The actuation button 106 may serve a number of functions and may be used to control the depth of penetration of the lancet in the user as well as actuating the lancet.

In the closed position, the housing cover portion 104 is pivoted relative to the body portion 102 such that it overlaps the body portion thereby covering the actuating button 106 located therein. A protrusion 108 on the under surface of the housing cover portion 104 may be located in a corresponding depression 110 in the upper face 111 of the body portion 102 to retain the housing cover portion in the closed position on the body portion.

In a further preferred embodiment as shown in FIGS. 9a and 9b, a device 120 may comprise a number of lancets 122 all or part of which may be made of a plastics material, such as a polymer, hardened according to the method described above with reference to FIG. 1, or of some other material(s), such as metal. The device of FIGS. 9a and 9b may preferably and advantageously be used for allergy testing purposes.

In this preferred embodiment, the device comprises an annular portion 124 which is frustro-conically shaped and has a cover 126 formed of, for example, aluminum foil. A backing portion 127 is arranged on the opposing face to the cover portion 126 and the backing portion extends across the central aperture bounded by the annular portion 124.

A number of compartments 128 are provided in the annular portion 124 into which various substances may be placed to which the allergic reaction of a user is to be tested. The compartments 128 are circumferentially spaced from one another in the annular portion 124. The plurality of lancets 122, which may be in the form of needles, are arranged such that each compartment 128 has an associated needle (or lancet) which extends radially into its associated compartment with one end of the needle extending into the inner aperture bounded by the annular portion 124.

In the rest position, the needles are withdrawn such that they do not extend out of the outer peripheral wall of the annular portion 124. The needles 122 are mounted radially with the non-sharp end being located towards the centre of the aperture bounded by the annular portion 124.

A flexible member 130 is located in the central aperture bounded by the annular portion 124 and, in the rest position, the flexible member 130 projects away from the backing portion 127 and between the non-sharp ends of the needles 122.

To operate the device shown in FIGS. 9a and 9b, the flexible member 130 is manually deflected such that it is pushed against the non-sharp end of the appropriate needle thereby forcing the needle 122 outwardly through the associated compartment 128 and through the cover 126 over that compartment so that it may be used to scratch the skin of the user of the device. The fluid substance contained in the compartment which has been pierced by its associated needle, may flow along the needle and out of the compartment onto the skin of the user at the location of the scratch caused by the associated needle 122.

The flexible member 130 is then depressed against the next needle and the procedure is repeated until all needles have been used and thus all substances contained in the compartments 128 have been applied to the users skin. The users reaction to the various substances may then be observed.

The devices and methods embodying the invention have particular application in medical components, such as lancets, and an additional advantage to be gained from plastics products treated according to the present invention is that the component may be placed on a hotplate after use to melt the sharp edge giving a rounded edge which is not capable of inflicting puncture wounds and may therefore be disposed of by normal means rather than the safety containers normally required for sharp instruments.

Similarly, devices and methods embodying the invention may have particular use in disposable medical implements such as scalpels, and surgical scissors.

In a further preferred embodiment, antibacterial agents may be included in the hardened plastics material to inhibit bacterial contamination.

The plastics components whose surface(s) are to be hardened may be formed using an injection moulding process and may also be co-moulded with different types of material.

Whilst the embodiments including any of the magazines shown FIGS. 4 to 6 and 9a and b are illustrated and described for use with a plurality of lancets, it will be appreciated that the magazines could be used to retain and dispense other components, such as toothpicks.

Furthermore, whilst methanol has been referred to in the embodiment of FIG. 1 as an example of the chemical substance for enabling a miscible mixture of substances to be created in the pressure vessel, another substance could be used, for example ethanol.

It will be understood that the present disclosure is for the purpose of illustration only and other variations may be made to the features described. The foregoing is not to be construed as limiting. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1-54. (canceled)

55. A method for hardening at a surface a component, the component being formed of a plastics material, the method comprising the steps of:
softening the component at a surface using supercritical carbon dioxide, and
incorporating into the component at the surface a material to harden the surface.

56. A method according to claim 55, wherein the step of incorporating a material into the component comprises incorporating a ceramic material into the component to harden the component.

57. A method according to claim 55, wherein the step of softening the component using supercritical carbon dioxide comprises:
placing the component in a pressure vessel;
introducing into the pressure vessel an amount of carbon dioxide; and
increasing the pressure and temperature in the pressure vessel such that the carbon dioxide becomes supercritical to soften the component at a surface.

58. A method according to claim 57, wherein the step of introducing into the pressure vessel an amount of carbon dioxide comprises introducing into the pressure vessel a mixture of carbon dioxide and a predetermined substance for enabling a miscible blend of substances to be created.

59. A method according to claim 58, wherein the step of introducing a mixture comprises introducing a mixture of carbon dioxide and methanol or ethanol.

60. A method according to claim 55, wherein the step of incorporating into the softened component a material comprises applying to the softened component a metal alkoxide reagent to incorporate a ceramic into the softened component.

61. A method according to claim 60, wherein step of applying the metal alkoxide reagent comprises applying tetraethoxysilane (TEOS) and/or titanium isoproxide (TiOP).

62. A method according to claim 60, wherein the step of applying the metal alkoxide reagent comprises using the supercritical carbon dioxide as a carrier for the metal alkoxide reagent.

63. A method according to claim 60, further comprising the steps of:
introducing water into the pressure vessel after the step of incorporating a material into the softened component; and
increasing the pressure and the temperature in the pressure vessel after the step of introducing the water to induce hydrolysis and condensation reactions in the metal alkoxide reagent incorporated into the softened component for producing one or more substantially continuous ceramic domains in the surface.

64. A method according to claim 63, wherein the step of increasing the pressure after introducing the water comprises increasing the pressure up to around 150 bar (15 MPa).

65. A method according to claim 63, wherein the step of increasing the temperature after introducing the water comprises increasing the temperature up to around 120 C.

66. A method according to claim 63 when appended to claim 4, further comprising reducing the pressure in the pressure vessel after the step of increasing the pressure and the temperature in the pressure vessel following the introduction of the water.

67. A method according to claim 66, further comprising the step of adjusting the temperature of the pressure vessel to allow annealing and/or post curing techniques to be applied to the hardened surface of the component in the pressure vessel.

68. A method according to claim 55, wherein the step of incorporating into the component a material to harden the surface comprises incorporating the material into the surface of the component to a depth dependent on the plastics material from which the component is formed.

69. A method according to claim 60, wherein the step of incorporating into the component a material to harden the surface comprises incorporating the material into the surface of the component to a depth dependent on the time for which the plastics material is exposed to the metal alkoxide reagent and/or the pressure applied to the softened component.

70. A method according to claim 68, wherein the step of incorporating the material comprises incorporating the material into the component to a depth of up to around 50 microns.

71. A method according to claim 68, wherein the step of incorporating the material comprises incorporating the material into the component to a depth of up to around 20 microns.

72. A method according to claim 55, wherein the plastics material comprises a polymer material.

73. A device having one or more surfaces hardened according to the method of claim 55.

74. A device according to claim 73 wherein the device comprises a lancet having a tip.

75. A device according to claim 74, wherein the one or more hardened surfaces are on the tip of the lancet.

76. A device comprising a plurality of components, one or more of the components having one or more surfaces hardened according to the method of claim 55, the plurality of components being arranged in a disc portion, the device further comprising means for moving one or more of the components from a rest position to an in use position.

77. A device according to claim 76, wherein the disc portion is substantially planar in a first plane.

78. A device according to claim 76, wherein the plurality of components comprises a plurality of lancets each having a tip portion, the tip portion having one or more of the one or more hardened surfaces.

79. A device according to claim 76, wherein the components each have a tip portion, the tip portion having one or more of the one or more hardened surfaces.

80. A device according to claim 78, wherein the tip portion of each component extends in a plane substantially parallel to the first plane.

81. A device according to claim 78, wherein the tip portion of each component extends in a plane substantially perpendicular to the first plane.

82. A device according to claim 78, wherein the tip portion of each component extends from a free end portion of the component, each component having a fixed end attached to a central disc portion, the components extending radially from the central disc portion, and the free end of each component being spaced from the free end of the adjacent component to permit independent movement of the tip portion of each component between the rest position and the in use position.

83. A device according to claim 78, wherein the means for moving the components comprises a spring mechanism, the spring mechanism having a resiliently biased portion and a contact portion, wherein the resiliently biased portion is arranged such that when it is biased against its natural bias the resiliently biased portion urges the contact portion into contact with one of the plurality of components to move the component to the in use position.

84. A device according to claim 83, wherein the resiliently biased portion is arranged such that on return to its naturally biased state the resiliently biased portion allows the component to move from the in use position to the rest position.

85. A device according to claim 83, wherein the means for moving the components further comprises means for rotating the disc portion.

86. A device according to claim 78, wherein the means for moving the components comprises a first section and a second section, the first and second sections being joined by a hinge, the tip portion of the components being attachable to one or other of the first and second portions, the first and second sections being arranged such that in use pressure applied to the hinge of any one of the plurality of components causes movement of that component to the in use position and/or the rest position.

87. A device according to claim 86, wherein the first and second sections are integrally formed.

88. A device according to claim 86, wherein the tip portion is joined to one or other of the first portion or the second portion by a hinge.

89. A device according to claim 78, wherein the disc portion comprises:
a cover portion;
a base portion;
an annular body portion extending between the base portion and the cover portion;
a recess bounded by the annular body portion; and
a plurality of compartments within the annular body portion, each compartment being associated with a corresponding component from the plurality of components, the compartments being arranged to contain a fluid substance;
wherein each component is spaced from any one or more of the other components and is arranged in use to extend through the compartment associated with the component and into the recess; and
wherein the means for moving each component is locatable in the recess, the means for moving being arranged such that actuation of the means for moving causes a component to move from the rest position to the in use position in which the tip of the component pierces the cover portion and extends therethrough to permit egress of fluid from the associated compartment.

90. A device according to claim 89, wherein the body portion is a frustro-conically shaped annular portion tapering from the base portion to the cover portion.

91. A device for retaining and presenting for use one or more components, the device comprising a plurality of components, arranged in a disc portion, the device further comprising means for moving one or more of the components from a rest position to an in use position.

92. A device according to claim 91, wherein the disc portion is substantially planar in a first plane.

93. A device according to claim 91, wherein the plurality of components comprises a plurality of lancets each having a tip portion.

94. A device according to claim 91, wherein the components each have a tip portion.

95. A device according to claim 93, wherein the tip portion of each component extends in a plane substantially parallel to the first plane.

96. A device according to claim 93, wherein the tip portion of each component extends in a plane substantially perpendicular to the first plane.

97. A device according to claim 93, wherein the tip portion of each component extends from a free end portion of the component, each component having a fixed end attached to a central disc portion, the components extending radially from the central disc portion, and the free end of each component being spaced from the free end of the adjacent component to permit independent movement of the tip portion of each component between the rest position and the in use position.

98. A device according to claim 93, wherein the means for moving the components comprises a spring mechanism, the spring mechanism having a resiliently biased portion and a contact portion, wherein the resiliently biased portion is arranged such that when it is biased against its natural bias the resiliently biased portion urges the contact portion into contact with one of the plurality of components to move the component to the in use position.

99. A device according to claim 98, wherein the resiliently biased portion is arranged such that on return to its naturally biased state the resiliently biased portion allows the component to move from the in use position to the rest position.

100. A device according to claim 98, wherein the means for moving the components further comprises means for rotating the disc portion.

101. A device according to claim 93, wherein the means for moving the components comprises a first section and a second section, the first and second sections being joined by a hinge, the tip portion of the components being attachable to one or other of the first and second portions, the first and second sections being arranged such that in use pressure applied to the hinge of any one of the plurality of components causes movement of that component to the in use position and/or the rest position.

102. A device according to claim 101, wherein the first and second sections are integrally formed.

103. A device according to claim 101, wherein the tip portion is joined to one or other of the first portion or the second portion by a hinge.

104. A device according to claim 93, wherein the disc portion comprises:
a cover portion;
a base portion;
an annular body portion extending between the base portion and the cover portion;
a recess bounded by the annular body portion; and
a plurality of compartments within the annular body portion, each compartment being associated with a corresponding component from the plurality of components, the compartments being arranged to contain a fluid substance;
wherein each component is spaced from any one or more of the other components and is arranged in use to extend through the compartment associated with the component and into the recess; and
wherein the means for moving each component is locatable in the recess, the means for moving being arranged such that actuation of the means for moving causes a component to move from the rest position to the in use position in which the tip of the component pierces the cover portion and extends therethrough to permit egress of fluid from the associated compartment.

105. A device according to claim 104, wherein the body portion is a frustro-conically shaped annular portion tapering from the base portion to the cover portion.

106. A blood sugar level monitor comprising the device of claim 76.
